(19) United States
(12) Patent Application Publication
(10) Pub. No.: US 2002/0066046 A1
(43) Pub. Date: May 30, 2002

(54) Apparatus for directly connecting to the internet and method thereof

(76) Inventor: Chin-Shuing Liu, Taipei (TW)

Correspondence Address: J. C. PATENTS INC., 4 Venture, Suite 250, Irvine, CA, 92618, US

(21) Appl. No.: 09/801,333

(22) Filed: Mar. 7, 2001

(30) Foreign Application Priority Data
Oct. 24, 2000 (TW) 89122371

(51) Int. Cl. G06F 1/26; G06F 1/28; G06F 1/30

(52) U.S. Cl. 713/300

(57) ABSTRACT

An apparatus for directly connecting to the Internet and a method thereof. The apparatus comprises at least a functional start key, a latch circuit, an embedded controller, a switch device and a storage device. When the power of the apparatus is not turned on, the functional start key is triggered to operate the latch circuit, the embedded controller, and trigger the power start device to turn on the power of the apparatus. A basic input and output system is provided to store a storage code into the storage device. Finally, the driving device starts a driving application program after checking the storage code. If the power of the apparatus is turned on, once the functional key is triggered, the system is connected to the latch circuit directly and a scan signal is produced from the controller. The scan signal is then transmitted into the driving device to perform a checking process. Finally, the driving device starts a driving application program after checking the storage code.

### CROSS-REFERENCE TO RELATED APPLICATION

This application claims the priority benefit of Taiwan application serial no. 89122371, filed Oct. 24, 2000.

### BACKGROUND OF THE INVENTION

1. Field of Invention

The present invention relates to an apparatus performing a special function. More particularly, the present invention relates to an apparatus for directly connecting to the Internet and a method thereof

2. Description of the Related Art

In recent years, the popularity of computers has increased tremendously. It has almost reached a point in which every family will have at least one computer. Internet service provides various information and news around the world, which is very easily obtained. Therefore more and more people are using Internet services to look for information, programs or pictures that they need.

However, even with the rapid development in Internet technology, users still face a lengthy connecting process from the point of switching to power on a computer, starting to boot, running a program to show a window frame, completing a presentation of tool bars, running virus scanning programs, etc., and connecting to the Internet. In order to connect to the Internet, the user must concurrently check whether the computer system is booted properly, so as to select the programs or icons to connect to the Internet. For a user who frequently wants to run Internet programs, such as a browser, e-mail, etc., the whole process does not provide an effective and efficient operation.

### SUMMARY OF THE INVENTION

It is an object of the present invention to provide an apparatus and a method for a more effective and efficient operation of connecting to the Internet. When a functional start key is switched on, the start key can automatically switch on the power of a computer and connect to an Internet network, avoiding the various input operations and key-in commands of frequently watching the operation of Internet program or operating system (OS) programs, etc.. Less time and energy is required to start the process in order to connect to the Internet. Once the computer is under the power-on state, it will not restart to boot and repeat the start process, even if the start key is pressed by mistake or during the connection to the Internet. This invention is designed for computers to connect directly to the Internet. The apparatus comprises a power start device, at least one functional start key, a latch circuit, an embedded controller, a switch device, a storage device and a monitoring device. The functional start keys, which are installed on the computer, produces a starting signal after pressed. When the latch circuit, which is connected to the functional start keys, receives the starting signal, a latch signal is produced from the latch circuit to the embedded controller. The embedded controller then produces a scan signal after receiving the latch signal. The switch controller is connected to the latch circuit and the power start device respectively. The function of the switch controller is to control whether the latch signal is transmitted to the power start device. The storage device stores data, such as storage code, and a monitoring device scans the scan signal that is produced from the embedded controller. The monitoring device stores the scan signals into the storage device after detecting the scan signal.

The computer apparatus of the present invention further comprises a driving device that drives a plurality of application programs. The functional start key has many functions, for example, including but not limited to, directly connecting to the Internet (internet, on-line), connecting to a search engine (Internet search), connecting to a favorite website (my favorite), and directly receiving e-mail (check e-mail), etc. The storage device is made of a CMOS structure, which can allow the user to set the storage code and the scan signal to be the same. The monitoring device is, for example, a basic input and output system (BIOS).

The present invention further provides a method of directly connecting to the Internet. The method comprises the following steps. A starting signal is produced first and used to create a latch signal. The latch signal is used to produce a scan signal. Then, the apparatus checks whether the power of a computer system is switched on/off If the power of the computer is off, the system firstly switches on the power, stores the scan signal and finally performs an erasing operation to erase data. Next the apparatus starts to drive the driving device. Once the scan signal is scanned, the functional operation, such as the functional operations of application programs, can be carried out. On the other hand, if the power of a computer is switched on already, then the scan signal will initiate to carry out functional operations.

It is another object of the present invention to provide a computer that can directly connect to the Internet. The computer comprises: a central processing unit (CPU), a display controller, a main memory, a north bridge, a PCI bus, a network controller, a multi-peripheral supporting device, an input and output controller, a south bridge, a basic input and output system and an Internet direct connection driving apparatus, for example, the apparatus for directly connecting to the Internet of the present invention.

The CPU controls all files, and the display controller controls a display function, wherein the display controller displays words and pictures. The main memory can record, store and retrieve data. In order to control and combine all the functions mentioned above, the north bridge is connected to the CPU, the display controller and the main memory. The PCI bus is connected to the north bridge in order to carry out information transmission. The network controller is connected to the PCI bus to carry out the Internet connection process. The multi-peripheral supporting device assists the users to operate the system. The input and output controller receives all the input and output data from the users, wherein the input and output controller is connected to the PCI bus and the peripheral supporting device through the south bridge. This connection controls the whole operation of the peripheral supporting device and the input and output controller. In order to transmit a driving program, a basic input and output system is connected to the input and output controller, and an Internet driving device that can directly connect to the Internet is through the basic input and output system.

The Internet direct connection driving device produces a starting signal to the latch circuit by using the start key. The latch circuit produces a latch signal after receiving the starting signal, and the latch signal is transmitted to the embedded controller to produce a scan signal. The scan signal determines the power status of the computer, i.e., on/off If the power of a computer is off, the switch controller that has received the scan signal will produce a signal in order to switch on the power, store the scan signal and start the driving device. However if the power of a computer is already switched on, then the scan signal will start its operation.

The present invention further comprises a display controller that is connected to the graphical controller, and a display, which can be a TFT LCD. A peripheral device can be, but is not limited to, a hard disc drive, a CD-ROM, a battery and a USB hub device. The USB hub device can be connected to a blue tooth. An input/output controller is connected to an outer input controller by using a PS/2 port method, a serial port method or a parallel port method, or by using the fluid card to serve as an output. The apparatus can include a sound controller that is connected to the PCI bus and a sound receiver that is connected to a sound controller. The sound receiver receives sound signals, and a sound transmitter is connected to the sound controller. The sound transmitter transmits sound signals. A cable is connected to the PCI bus and a wireless transmission set.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a process flow diagram of an apparatus, peripheral related circuit and software operation that can directly connect to the Internet according to a preferred embodiment of the present invention;

FIG. 2 is a process flow diagram of the setup of the present invention before switching on the power of a computer.

FIG. 3 is a process flow diagram of the setup of the invention after switching on the power.

FIG. 4 is a diagram of a computer structure that can directly connect to the Internet, according to a preferred embodiment of the present invention.

### DESCRIPTION OF THE PREFERRED EMBODIMENTS

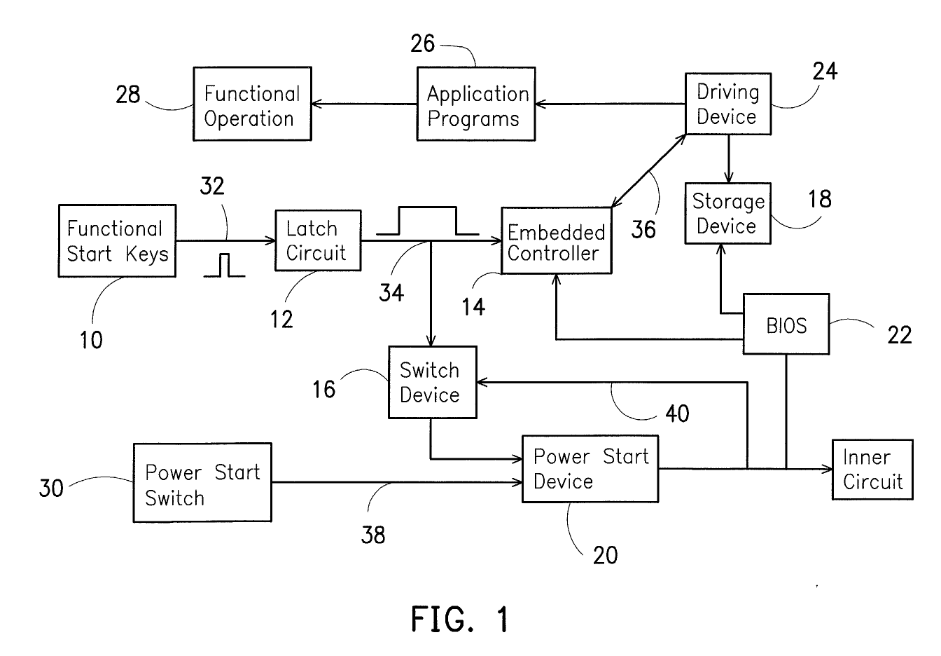

FIG. 1 illustrates an apparatus for directly connecting to the Internet and a method thereof in accordance with one embodiment of the present invention. The apparatus for directly connecting to the Internet comprises: a plurality of functional start keys 10, a latch circuit 12, a controller 14, a switch device 16 and a storage device 18. The other components regarding peripheral circuits and software operations comprise: a power start device 20, a monitoring device 22, a driving device 24, a plurality of application programs 26, a functional operation 28 and a power start switch 30.

The functional start keys 10 are installed on a housing of a computer, having functions for directly connecting to the Internet and retrieving electronic mail. When one of the functional start keys 10 is triggered, a starting signal is produced. The latch circuit 12, connected to the functional start key 10, produces a latch signal 34 after receiving the starting signal 32. The controller 14, coupled to the latch circuit 12, uses general purpose input/output (GPIO) (not shown on the diagram) for receiving the latch signal 34 and generating a scan signal 36 according to the latch signal 34. A switch device 16, connected to the latch circuit 12 and the power start device 20, controls whether the received latch signals 34 are transmitted to the power start device 20. The storage device 18 stores data and its operation will be described in detail below. The monitoring device 22 can serve as a monitoring device for software or hardware. In one embodiment of the present invention, the monitoring device 22 of present invention is, for example, a basic input and output system (BIOS).

During other software and circuit operations, the power start device 20 receives the latch signal that is transmitted from the switch device 16. In general, the computer uses a power start switch 30 to transmit a power start signal 38 for controlling the power start device 20 to switch on the power. The power start device 20 performs a BIOS operation 22 to erase and set up data of the whole system of the computer apparatus. A driving device 24 receives the input scan signal 36 from the controller 14 or checks the stored data from a CMOS structure (storage code), starting one of a plurality of application programs 26 and performing the functional operation 28.

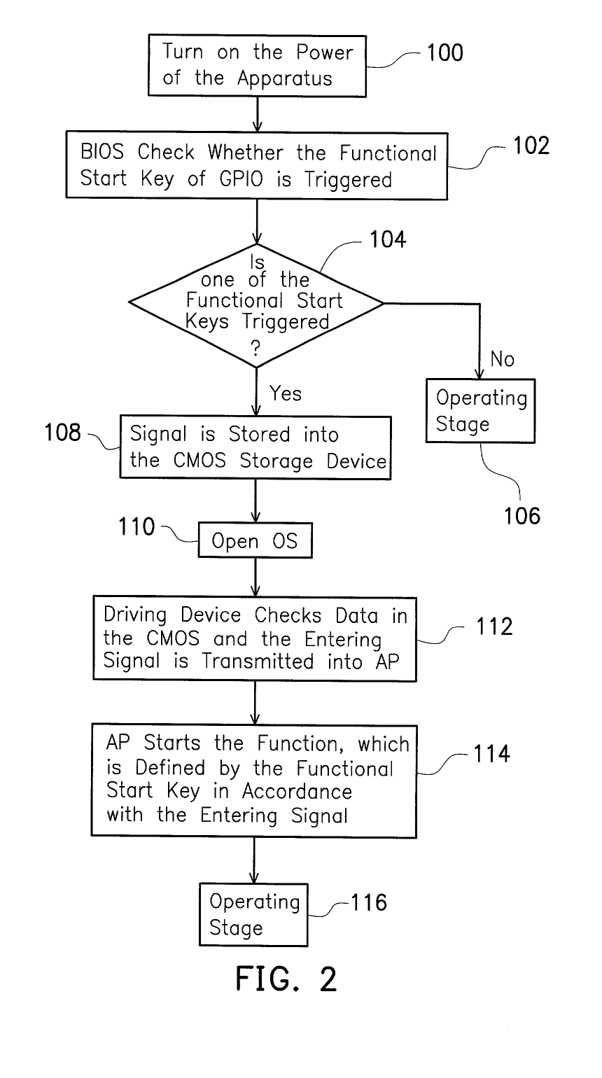

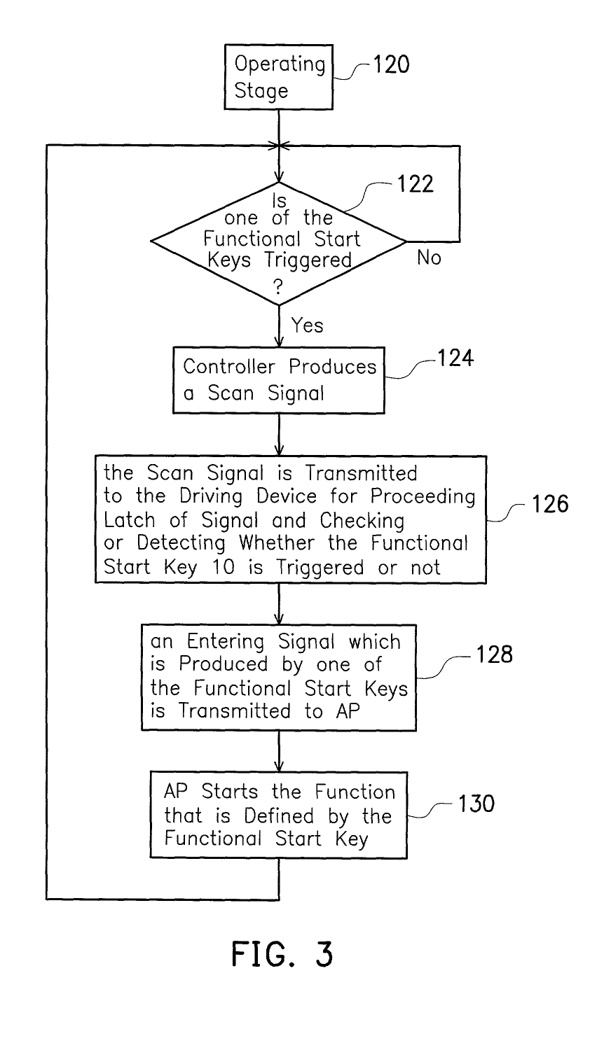

The operation of the apparatus for directly connecting to the Internet and a method thereof in accordance with the preferred embodiment of the present invention will be more clearly understood from the following detailed description taken with the diagrams. FIG. 2 illustrates a flow chart of triggering one of the functional start keys for starting the computer and connecting to the Internet when the computer is not switched on. FIG. 3 illustrates a flow chart of triggering one of the functional start keys for connecting to the Internet when the power of the computer is switched on. FIG. 1 illustrates a block diagram of an apparatus for directly connecting to the Internet, and a peripheral related circuit and a software operation.

First, when the power of the computer is off, the switch device 16 of FIG. 1 is turned-on. When one of the functional start keys 10 is triggered, a starting signal 32 is generated and transmitted into the latch circuit 12. A latch signal 34 is produced and transmitted from the switch device 16, which has been turned-on to the power start device 20. At this step, the computer system enters into the process shown in FIG. 2. In step 100, the power start device 20 is used for controlling the boot and switch powering on of the computer. A feedback signal 40 that is produced from FIG. 1 is transmitted to the switch device 16 to convert the switch device 16 into a turn-off state. A process of restarting the computer after one of the functional start keys is pressed again can be avoided. The power start device 20 performs a BIOS operation to clear or erase the signals. At this moment, the process is in step 102 of FIG. 2. The controller 14 uses the BIOS to check and monitor whether or not a pin of GPIO of controller 14 is asserted, i.e. whether or not one of the functional start keys is pressed. Next in step 104, the apparatus determines which one of the functional start keys is being triggered. From FIG. 1, if the power start switch 30 is turned on and it is not a result from triggering one of the functional start keys, the process will go to step 106 to continue the normal operation at the operating stage. However, if one of the functional start keys 10 is triggered, the process will then go to step 108.

Referring to FIG. 1, because one of the functional start keys 10 is being triggered, a starting signal 32 is produced and transmitted into the latch circuit 12. A latch signal 34 is thus produced and transmitted to the controller 14. A scan signal 36 is produced from the controller 14. Because the driving device 24 is not turned on, therefore the scan signal can not be transmitted and scanned. So the function of the BIOS 22 is to check and scan the scan signal and record the storage code (status) to the storage device 18, which is made of a CMOS structure. The storage code can use the same configuration as the scan signal. A signal is produced to the controller 14 for setting-up deleting and cleaning. Next in step 110, an operating system (OS) is run. In step 112, the driving device 24 of the computer apparatus is turned on, and the driving device 24 first checks the correction of the storage code in the storage device 18. Then an entering signal is produced to bring the computer system into the application programs 26.

In step 114, the application programs 26 are triggered to start the functional operation, which is defined by the functional start key according to the entering signal, in order to execute the functional operation. Then in step 116, the computer system will continue its normal operating program at the operating stage.

Next, a description of the operation process when the power of the computer is turned on and one of the functional keys 10 is triggered is provided. When the power of the computer is turned on the first time, the power start device 20 will produce a feedback signal 40 to the switch device 16. The switch device 16 will then change to a turn-off state. FIG. 3 shows a diagram for simple functional operations (for example connecting to the Internet) and a flow chart diagram for a computer that has not been switched on and booted. Step 120 is a step for a normal operating process. However, in step 122, the computer system checks whether one of the functional keys 10 is triggered or not. If it is not, the system will repeat the checking step. But if the functional key 10 is triggered, then the process will go to step 124. We can see from the flow chart diagram of FIG. 1 that if the functional chart key 10 is triggered, then a starting signal 32 is produced and transmitted into the latch circuit 12. The latch circuit 12 will produce a latch signal 24 and transmit the latch signal 24 to an embedded controller 14. The embedded controller 14 will produce a scan signal 36. Next in step 126, the scan signal 36 will be transmitted to the driving device 24 for performing latch of signal and checking whether the functional start key 10 is triggered or not. In step 128, an entering signal is transmitted to application programs 26. Next in step 130, the application programs 26 start the functional operation that is defined by the functional start key 10 according to the entering signal. Next, the system goes back to step 122 to check whether the functional start key is turned on or not.

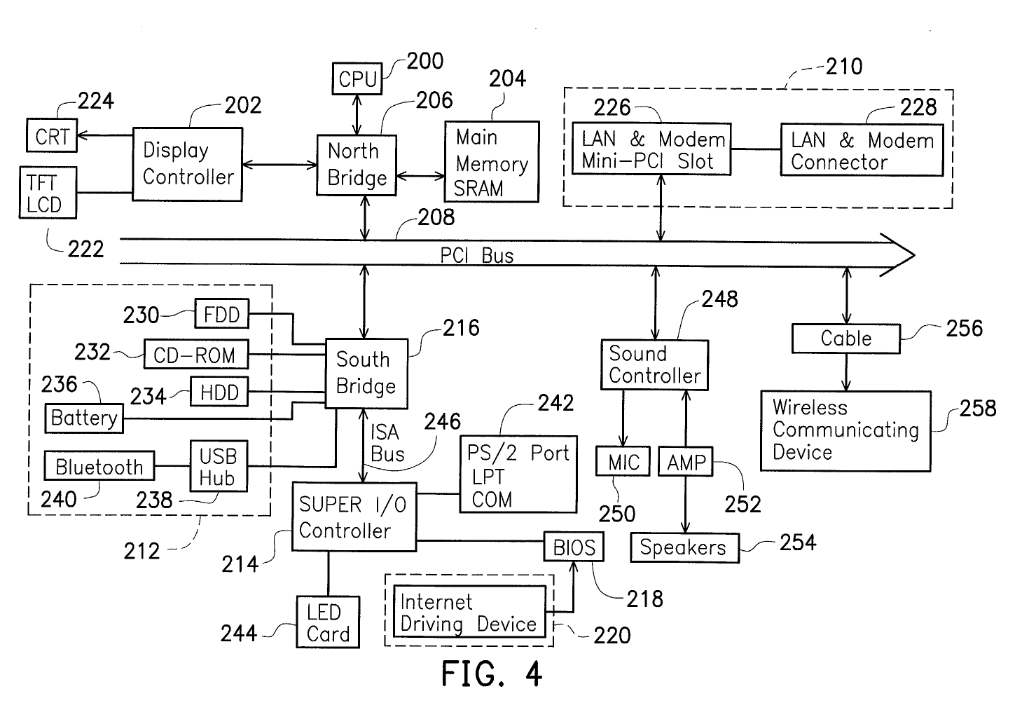

FIG. 4 illustrates a block diagram of a computer for directly connecting to the Internet in accordance with a preferred embodiment of the present invention. In FIG. 4, a main computer structure comprises: a CPU 200, a display controller 202, a main memory 204, a north bridge 206, a PCI bus 208, a network connecting controller 210, a plurality of peripheral devices 212, an input and output controller 214, a south bridge 216, a BIOS 218 and an Internet driving apparatus 220.

The CPU 200 controls all operation data. The display controller 202 controls the processing of images and further displays text and drawings to a TFT LCD 222 or/and CRT 224. The main memory can be made of a SDRAM, an EDO DRAM, a DDR DRAM or a RAMBUS DRAM. The main memory function is to store and retrieve data. In order to combine all these circuits, the CPU 200, the display controller 202 and the main memory 204 are all connected to the north bridge 206. The PCI bus 208, which is connected to the north bridge 206, transmits data. The network connecting controller 210 has a LAN & modem mini-PCI slot 226, which is connected to the PCI bus 208. Another LAN & modem mini-PCI slot 228 is connected to the LAN & modem mini-PCI slot 226 for connecting to the Internet.

The peripheral devices 212 are for assisting a user to operate the computer, for example, FDD 230, CD-ROM 232, HDD234, battery 326 and USB HUB 238. Among these devices, the USB HUB device is connected to a blue tooth 240. An input and output controller 214 receives data input or output from the user. The south bridge 216 is connected to the PCI bus 208, the peripheral devices 212 and the input and output controller 214, for combining all operations from the peripheral devices 212 and the input and output controller 214. The input and output controller 214 can use a PS/2 port, a serial port and a parallel port to connect to an external input device (not shown). The input and output controller 214 is then connected to an LED card 244 to provide an output.

The BIOS is connected to the input and output controller 214, and the Internet driving apparatus 220, which is, for example, the apparatus shown in FIG. 1, is connected to the BIOS 218 for transmitting a driving data to the BIOS 218 in order to directly connect to the Internet. The computer structure of the present invention further comprises: a sound controller, which is connected to the PCI bus 208 and has a sound receiver 250, for example a microphone. The microphone is connected to the sound controller 248 for receiving a sound signal, and a sound transmitter such as a speaker 254 and an amplifier device 252. The sound controller 248 transmits sound signals. On the other hand, the computer structure further comprises a cable 256, which is connected to the PCI Bus 208 and a wireless communicating device 258.

According to the above-mentioned embodiment, the advantages of the present invention is that when the power of the computer is turned on, the computer is directly connected to the Internet without performing any additional operations. By directly connecting to the internet, electronic mail can be received rapidly, Internet searching can be performed, mail can be checked, or the user can connect to favorite websites.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for directly connecting to the Internet, the apparatus being adapted to a computer, the apparatus comprising:
a power start device;
one or more functional start keys installed in the computer, for generating a starting signal;
a latch circuit, coupled to the functional start key, for receiving the starting signal and producing a latch signal according to the starting signal;
a controller, coupled to the latch circuit, for receiving the latch signal and generating a scan signal according to the latch signal;
a switch device, coupled to the latch circuit and the power start device, for controlling whether the received latch signal is transmitted to the power start device;
a storage device for storing data; and
a monitoring device for monitoring whether the scan signal is generated by the controller, wherein when the scan signal is generated, the scan signal is input and stored in the storage device.

2. The apparatus of claim 1, further comprising a driving device for driving a plurality of application programs.

3. The apparatus of claim 1, wherein one of the functional start keys has a function for directly connecting to the Internet and another functional start key has a function of retrieving electronic mail.

4. The apparatus of claim 1, wherein the storage device is a CMOS device.

5. The apparatus of claim 1, wherein the stored data in the storage device is the same as the scan signal.

6. The apparatus of claim 1, wherein the monitoring device is a basic input and output System (BIOS).

7. A method for directly connecting to the Internet, suitable for a computer, comprising:
producing a start signal;
producing a latch signal according to the start signal;
producing a scan signal according to the latch signal; and
detecting if the computer is turned on, wherein
when the computer apparatus is not turned on,
turning on the computer,
storing the scan signal,
proceeding a signal erasing process,
starting a driving program by the computer to check the scan signal, and proceeding functional operations; and
when the computer apparatus is turned on, proceeding functional operations by the scan signal.

8. The method of claim 7, wherein the step of producing the start signal is produced by triggering one of a plurality of functional start keys, each of the functional start keys having a specific function.

9. The method of claim 8, wherein one functional start key has a function for directly connecting to the Internet and the another functional start key has a function of retrieving electronic mail.

10. A computer having a function of directly connecting to the Internet, comprising:
a central processing unit (CPU), for controlling operations of data;
a display controller, for controlling processing of images and displaying texts and drawings of the images;
a main memory, for storing and retrieving data;
a north bridge, connected to the central processing unit, the display controller and the main memory, for integrating operations of the central processing unit, the display controller and the main memory;
a system bus, connected to the north bridge, for transmitting data;
a network connecting controller, connected to the system bus, for connecting to the Internet;
a plurality of peripheral devices, for assisting a user to operate the computer;
an input/output controller, for receiving data input or output by the user;
a south bridge, connected to the system bus, the peripheral devices and the input/output controller, for integrating operations of the peripheral devices and the input/output controller;
a basic input and output system (BIOS), connected to the input/output controller; and
an Internet driving apparatus, connected to the BIOS, for transmitting a driving program, wherein the Internet driving apparatus comprises
a power start device;
one or more functional start keys, for generating a starting signal,
a latch circuit, for receiving the start signal and producing a latch signal according to the start signal;
a controller, for receiving the latch signal and generating a scan signal according to the latch signal;
a switch device for controlling whether the received latch signal is transmitted to the power start device;
a storage device, for storing data;
a monitoring device, for monitoring whether the scan signal is generated by the controller; and
a driving device, for driving a plurality of application programs.

11. The computer of claim 10, wherein the computer further comprises a display device, connected to the display controller.

12. The computer of claim 10, wherein the display device is a TFT LCD.

13. The computer of claim 10, wherein the peripheral devices comprises a hard disc drive, a CD-ROM, a battery and a USB hub device.

14. The computer of claim 13, wherein the computer further comprises a blue tooth, for connecting to the USB hub device.

15. The computer of claim 10, wherein the computer further comprises a PS/2 port, for connecting to the input/output controller.

16. The computer of claim 10, wherein the computer further comprises a serial port for connecting to the input/output controller.

17. The computer of claim 10, wherein the computer further comprises a parallel port for connecting to the input/output controller.

18. The computer of claim 10, wherein the computer further comprises a LED card for connecting to the input/output controller.

19. The computer of claim 10, wherein the computer further comprises a sound controller for connecting to the PCI bus.

20. The computer of claim 19, wherein the computer further comprises a sound receiver, connected to the sound controller, for receiving sound signals, and a sound transmitter, connected to the sound controller, for transmitting sound signals.

21. The computer of claim 10, wherein the computer further comprises a cable for connecting to the PCI bus.

22. The computer of claim 21, wherein the computer further comprises a wireless communicating device for connecting to the cable.

23. The computer of claim 10, wherein the network connecting controller comprises a LAN & modem mini-PCI slot for connecting to the PCI bus and another LAN & modem mini-PCI slot for connecting to the modem mini-PCI slot.

24. The computer of claim 10, wherein the main memory is a SDRAM device.
